(19) United States
(12) Patent Application Publication
(10) Pub. No.: US 2014/0223291 A1
(43) Pub. Date: Aug. 7, 2014

(54) SYSTEM AND METHOD FOR RESTRUCTURING CONTENT ON REORIENTATION OF A MOBILE DEVICE

(71) Applicant: MOBILEMOTION TECHNOLOGIES PRIVATE LIMITED, Bangalore (IN)

(72) Inventor: Kush SHARMA, Bangalore (IN)

(73) Assignee: MOBILEMOTION TECHNOLOGIES PRIVATE LIMITED, Bangalore (IN)

(21) Appl. No.: 14/148,700

(22) Filed: Jan. 6, 2014

Related U.S. Application Data
(60) Provisional application No. 61/749,897, filed on Jan. 7, 2013.

(51) Int. Cl. G06F 17/21

(52) U.S. Cl. CPC G06F 17/211
USPC 715/238

(57) ABSTRACT

A system and method for restructuring content on a display screen of a mobile device is provided. The system comprises a content formatting application that is located within a web browser of the mobile device. The mobile device acquires the content from a website. The content is available in multiple web pages. The web pages are formatted for a first orientation or a second orientation on the display screen of the mobile device. The content formatting application determines page information for the first orientation and the second orientation of the display screen for each of the web pages and positions markers based on the determined page information. The content formatting application restructures the content based on the position of the markers on reorientation of the mobile device. The restructured content is then displayed on the display screen of the mobile device.

### FIELD OF INVENTION

The present invention, in general, relates to display of content in a mobile device. More particularly, the present invention relates to dynamically restructuring and formatting content for presentation on the mobile device on change in device orientation.

### BACKGROUND OF THE INVENTION

A mobile device, for example, a mobile phone, a tablet computer, a personal digital assistant (PDA), etc., typically comprises an elongated rectangular display screen used for displaying content. The content is, for example, textual content. The display screen of the mobile device may be oriented in more than one way with respect to a user viewing the content. In such mobile devices, when a user attempts to rotate the mobile device the content on the display screen is usually reoriented so as to correspond with the viewpoint of the user.

The display screen may be oriented in, for example, a vertically oriented position or a horizontally oriented position. The vertically oriented position and the horizontally oriented position are herein referred to as a “portrait orientation” and a “landscape orientation”, respectively. In the portrait orientation, the display screen accommodates more content than in the landscape orientation. Therefore, while presenting the content on the display screen, the content has to automatically be formatted and restructured when the mobile device is reoriented from a landscape orientation to a portrait orientation or vice versa.

Conventional methods for restructuring the content include restructuring text from the previous page. In this method, when the mobile device is reoriented, the webpage comprising the content is rendered based on the capacity and attributes of the current orientation instead of taking into account the attributes of both the previous orientation and the current orientation. For example, when the mobile device is reoriented from a portrait orientation to a landscape orientation, the web page is rendered based on the attributes of the landscape orientation. In some instances, this method leads to a loss of content in the rendered web page and the relevant content is not displayed on the display screen of the mobile device. Therefore, there is a need for restructuring content based on the attributes of both the previous orientation and the new orientation to produce relevant content in the rendered web page.

Hence, there is a long felt but unresolved need for a method and system for restructuring content for displaying relevant content on the display screen of the mobile device on reorientation of the mobile device.

### BRIEF DESCRIPTION OF THE INVENTION

The above-mentioned shortcomings, disadvantages and problems are addressed herein which will be understood by reading and understanding the following specification.

A system and method for restructuring content on a display screen of a mobile device is provided. The system comprises a content formatting application that is located within a web browser of the mobile device. The mobile device acquires the content from a website via the web browser. The content is available in a plurality of web pages and the web pages are formatted for a first orientation or a second orientation on the display screen of the mobile device.

The content formatting application determines page information for the first orientation and the second orientation of the display screen for each of the web pages. The page information comprises a first character and a last character of each of the web pages. The content formatting application positions markers on the web pages based on the determined page information. The content formatting application then restructures the content based on the position of the markers on reorientation of the mobile device from the first orientation to the second orientation or from the second orientation to the first orientation of the mobile device. The restructured content is then displayed on the display screen of the mobile device.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 illustrates a mobile device placed in portrait and landscape orientation, in accordance with the various embodiments of the present invention;

FIG. 2 exemplarily illustrates a system 200 for restructuring content on a display screen of a mobile device, in accordance with the various embodiments of the present invention;

FIG. 3 illustrates a flowchart 300 for a method for restructuring content on the display screen of the mobile device, in accordance with the various embodiments of the present invention; and

FIG. 4 illustrates a suitable handheld device for embodiments of the present invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

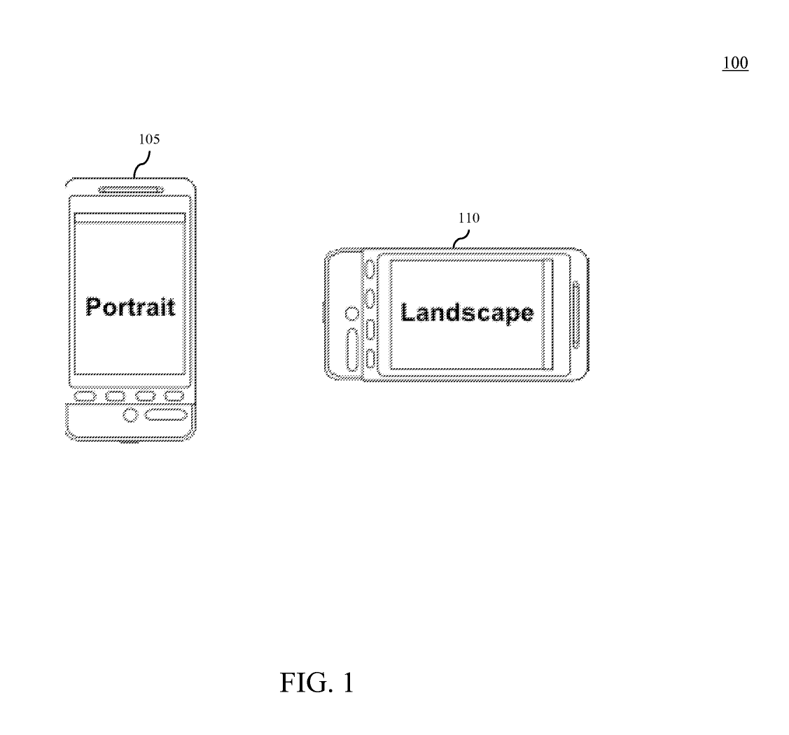

FIG. 1 illustrates a mobile device placed in portrait and landscape orientation. The mobile device 105 is placed in portrait orientation and the mobile device 110 is placed in landscape orientation. Further, the mobile device 105 and the mobile device 110 are the same. The mobile device 105 and the mobile device 110 is, for example, a cell phone, a smart phone, a personal digital assistant (PDA), a wireless email terminal, a laptop, a tablet computer such as an iPad®, etc. The content is, for example, textual content. For the purposes of illustration, the detailed description refers to textual content; however, the scope of the system 100 disclosed herein is not limited to textual content but may be extended to include images, video, etc.

Viewing orientation of the content on the display screen may be a first orientation and a second orientation. The first orientation and the second orientation are herein known as a “portrait orientation” and a “landscape orientation” respectively. In another embodiment, the first orientation can be landscape orientation and the second orientation can be a portrait orientation, the term “portrait orientation” refers to an orientation in which the length of the display screen is vertically oriented. The display screen in the portrait orientation is taller than it is wide. The term “landscape orientation” refers to an orientation in which the length of the display screen is horizontally oriented. The display screen in the landscape orientation is wider than it is tall. In the portrait orientation, the display screen accommodates more content than in the landscape orientation of the display screen. In an example, the display screen accommodates 60 characters in the portrait orientation and 40 characters in the landscape orientation.

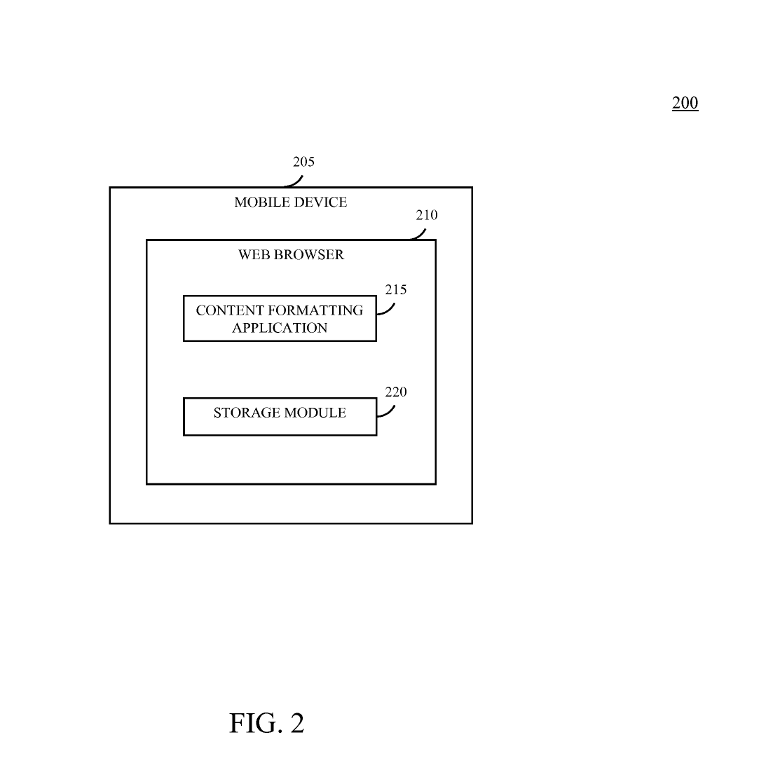

FIG. 2 exemplarily illustrates a system 200 for restructuring content on a display screen of a mobile device 205. Further, the mobile device 105, the mobile device 110 and the mobile device 205 are the same. The mobile device 205 acquires the content from a website. The content is rendered in multiple web pages that a user of the mobile device 205 can access, for example, by flipping or swiping across the display screen of the mobile device 205. The web pages refer to information resource that can be accessed through a web browser 210 and displayed on the mobile device 205.

The system 200 comprises a content formatting application 215 that is located within a web browser 210 of the mobile device 205. The term “web browser” 210 refers to a software application for retrieving, presenting, and accessing the web content on the World Wide Web from the mobile device 205. A request for the content may be sent from the mobile device 205 by typing the uniform resource locator (URL) of the desired website on the web browser 210 of the mobile device 205.

The content formatting application 215 determines page information for the portrait orientation and the landscape orientation of the display screen for each of the web pages. The page information comprises, for example, a first character, a last character, etc., in each viewing orientation in each of the web pages. As used herein, the term “first character” refers to the character at the start of a web page. Also as used herein, the term “last character” refers to the character at the end of a web page. Each of the web pages comprises a first character and a last character. As the user reads the content by flipping or swiping the web pages, the content formatting application 215 stores the page information of each web page.

Consider an example where the content of a website comprise 120 characters that are arranged in three web pages when in the landscape orientation and in two web pages when in the portrait orientation. That is, each of the web pages comprises 60 characters when in the portrait orientation and 40 characters when in the landscape orientation. In this example, the first character in the first web page in both viewing orientations is “A”. The last character of the first web page in the portrait orientation is the 60^{th} character, which is, for example, “user”. The last character in the first web page in the landscape orientation is the 40^{th} character, which is, for example, “communication”. Similarly, the first character and the last character of the second web page in the portrait orientation are the 61^{st} character “interface” and the 120^{th} character “device” respectively, and the first character and the last character of the second web page in the landscape orientation are the 41^{st} character “factor” and the 80^{th} character “computer” respectively.

The content formatting application 215 then positions markers on the web pages based on the determined page information. That is, the markers are placed on the first character and the last character on each of the web pages in both the viewing orientations. The page information and the markers are stored in a storage module 220 of the content formatting application 215.

The content formatting application 215 restructures the content of the web pages on reorientation of the display screen of the mobile device 205 based on the position of the markers. The display screen of the mobile device 205 is reoriented when the viewing orientation is changed from the portrait orientation to the landscape orientation or from the landscape orientation to the portrait orientation.

When the display screen is reoriented, the content formatting application 215 clears the existing web page from document object model (DOM) and recreates only the current web page and successive web pages from the page information and the markers, such that the first character remains the same on the web page that the user is currently viewing. Similarly, the web pages prior to the current web page are restructured by clearing and recreating the DOM with the same markers that these pages initially had, to maintain the same first character in each of these web pages. Therefore, when the user goes to a previous web page, the DOM is cleared in the current and the successive web pages. Further, the DOM is recreated in order to maintain continuity in the user's reading experience.

Further, the system 200 for restructuring content on a display screen of a mobile device consists of a storage module 220. The storage module 220 is web application software and protocols used for storing data in a web browser 210. Storage module 220 supports data storage on mobile device 205 with an enhanced capacity. Storage module 220 stores the information in one or more ways. In an embodiment, the storage module 220 stores the information in a local storage. The local storage in the storage module 104 is similar to persistent cookies. The information stored in the local storage has no expiration date. That is, information placed in local storage is per origin. The information is available to all scripts loaded from pages from the same origin that previously stored the information and persists after the browser is closed. In another embodiment, the storage module 220 stores the information in session storage. The session storage in the storage module 220 is similar to session cookies. The information in session storage is stored only for one session. Session storage is per-page-per-window and is limited to the lifetime of the window. Session storage is intended to allow separate instances of the same web application to run in different windows without interfering with each other.

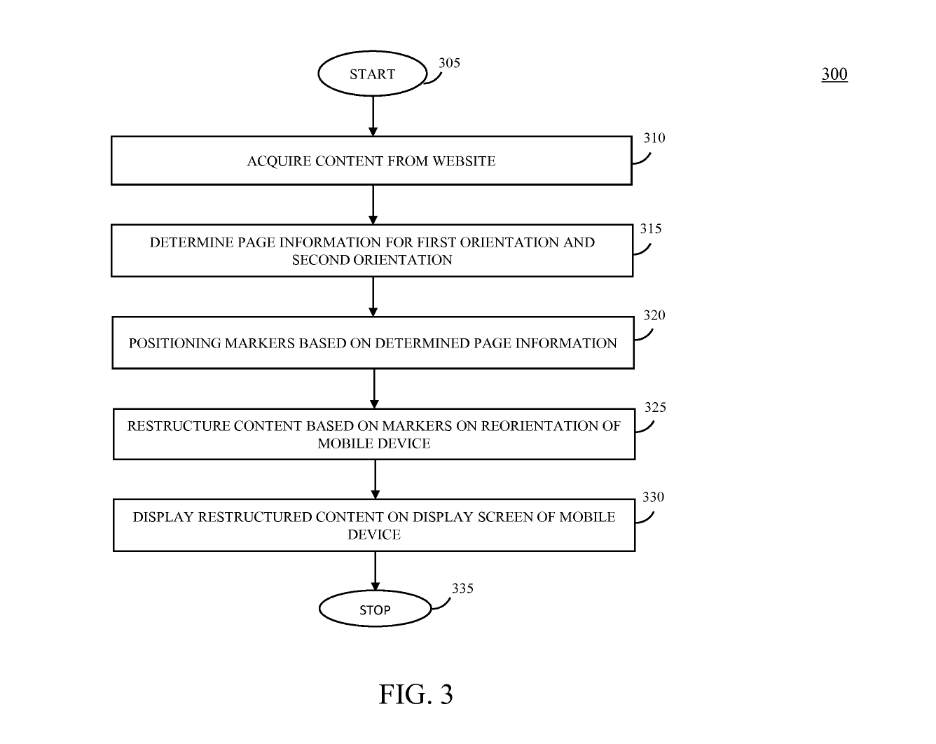

FIG. 3 illustrates a flowchart 300 for a method for restructuring content on a display screen of a mobile device 205. The flowchart initiates at step 305. At step 310, the mobile device acquires the web content. In an embodiment, the user types the web content to be acquired. The user can enter a uniform resource locator (URL) in the address box of a web browser operating on the wireless communication device. By the user pressing send, the mobile device 205 can wirelessly access and receive a web page on a remote server. In another embodiment, the mobile device 205 acquires the web content when the user clicks on an advertisement rendered by a publisher when the user is browsing. One of ordinary skill in the art will recognize other ways to access and receive a web page, for example, click on a hyperlink embedded in a web page displayed on the display screen, or running an application that automatically accesses a web site.

Further, at step 315, the mobile device 205 determines the orientation of the received. In an embodiment, the mobile device 205 determines the orientation of the device. In an embodiment, sensors placed at the corners of the mobile device 205 determine the change in the orientation. In another embodiment, orientation sensors placed at different places on the mobile device 205 determines the change in orientation. In yet another embodiment, a gyroscope present in the mobile device 205 determines the device orientation. In yet another embodiment, the magnetometer present in the mobile device 205 determines the orientation in which the web content was received. Once the mobile device 205 determines the orientation in which the requested web content was rendered, it is forwarded to step 230.

Further, at step 320, the markers are placed on the first character and the last character on each of the web pages in both the viewing orientations. The markers are embedded with the content of the requested web content. The page information and the markers are stored in a storage module 220 of the content formatting application.

Furthermore, at step 325, the content formatting application present in the mobile device 205 formats the web content in the required orientation. For example, the obtained web content is oriented to landscape orientation from portrait orientation when the mobile device is reoriented or vice-versa. Furthermore, at step 325, the content formatting application 215 restructures the text in the reoriented direction upon identifying the change the orientation of the mobile device 205. In an embodiment, the content formatting application 215 triggers the script in which the web content is written to reflow the text to fit the boundaries of the changed orientation. For example, the script can be java script. Accordingly, a reflow algorithm triggers the java script to reflow the text from one orientation to the other. The re-structuring of the web-content is done based on the positioning of the markers. The markers detect the first and last character of the current page and restructures accordingly.

Furthermore, at step 325 the restructuring is done by clearing the Document Object Model (DOM) of the webpage. When the mobile device 205 is reoriented, the existing page from the Document Object Model (DOM) is cleared. Further, only the page that was cleared from Document Object Model (DOM) is recreated and displayed to the user. Furthermore, only the further pages are reoriented by clearing Document Object Model (DOM) from the information that has been stored in the storage module 220, so that the first word remains same on the page that user was currently viewing. The pages before existing page are reoriented by the web browser 210 by clearing and recreating Document Object Model (DOM) but with the same markers that those had initially to maintain same start of page text. Further, if the user goes to the previous page, the Document Object Model (DOM) is cleared of that page and the ones after the existing page to maintain continuity in user is reading experience.

Furthermore, at step 330, the restructured content, displayed to the user. The user can see the transformation of the web content of the existing page when the mobile device is reoriented for the first time, but the subsequent pages will maintain the continuity. This will enhance the user's reading experience. The advantage of the present invention is that, the user when switching from first orientation to second orientation or vice-versa, the content will be presented from where the user reoriented the page. This is possible by positioning of the markers.

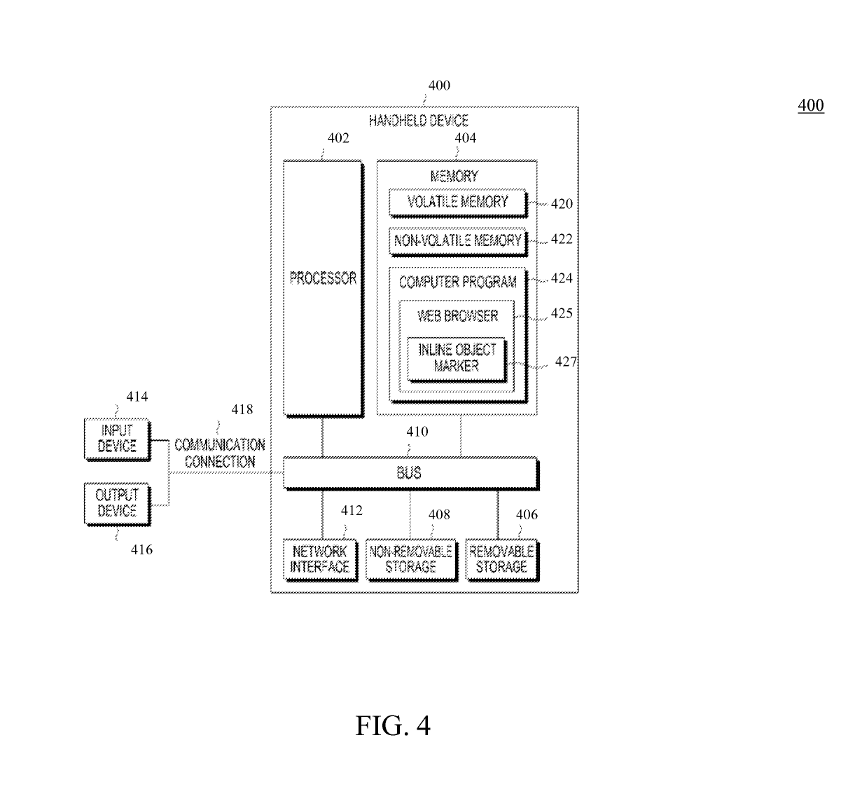

FIG. 4 illustrates a suitable handheld device for implementing embodiments of the present invention. A general handheld device 400, such as a palmtop, PDA, smart phone, a mobile phone, or tablet, may include the processor 402, the memory 404, a removable storage 406, and a non-removable storage 408. The handheld device 400 additionally includes a bus 410 and a network interface 412. The handheld device 400 may include or have access to at least one user input device 414, at least one output device 416, and at least one communication connection 418 such as a network interface card or a universal serial bus connection. The at least one user input device 414 may be a keyboard and/or mouse. The at least one output device 416 may be a display and/or other output devices. The communication connection 418 may include, for example, a Local Area Network (LAN), Wide Area Network (WAN), and/or a General Packet Radio Service (GPRS). Furthermore, the handheld device 400 and the mobile device 105 and the mobile device 205 are the same.

The memory 404 may include volatile memory 420 and non-volatile memory 422. A variety of computer-readable storage media may be stored in and accessed from the memory elements of the handheld device 400, such as the volatile memory 420 and the non-volatile memory 422, the removable storage 406 and the non-removable storage 408. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and Memory Sticks.

The processor 402, as used herein, refers to any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 402 may also include embedded controllers, such as generic or programmable logic devices or arrays, application specific integrated circuits, single-chip computers, and smart cards.

Embodiments of the present invention may be implemented in conjunction with program modules, including functions, procedures, data structures, and application programs, for performing tasks, or defining abstract data types or low-level hardware contexts.

Machine-readable instructions stored on any of the above-mentioned storage media may be executable by the processor 402 of the handheld device 400. For example, a computer program 424 may include a web browser 425 having an object marker module 427 in the form of machine-readable instructions capable of notifying a user of the handheld device 400 when at least one object is downloaded, according to the teachings herein. The machine-readable instructions may cause the handheld device 400 to encode according to the embodiments of the present invention.

This written description uses examples to describe the subject matter herein, including the best mode, and to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for restructuring content on a display screen of a mobile device, comprising:
a. acquiring the content from a website by the mobile device, wherein the content is available in a plurality of web pages, and wherein the web pages are formatted for one of a first orientation and a second orientation on the display screen of the mobile device;
b. determining page information for the first orientation and the second orientation of the display screen for each of the web pages, wherein the page information comprises a first character and a last character of each of the web pages;
c. positioning markers on the web pages based on the determined page information;
d. restructuring the content based on position of the markers on reorientation of the mobile device from one of the first orientation to the second orientation and from the second orientation to the first orientation of the mobile device; and
e. displaying restructured content on the display screen of the mobile device.
f.

2. The method of claim 1, wherein the first orientation is a portrait orientation and the second orientation is a landscape orientation.

3. The method of claim 1 further comprises launching the landscape-oriented browser that can display the received web page.

4. The method of claim 1 further comprises launching the portrait-oriented browser that can display the received web page.

5. The method of claim 1 further comprising
a. when the received web page is formatted for portrait orientation on the display screen, automatically displaying the received web page in portrait orientation on the display screen.

6. The method of claim 1 further comprising:
a. when the received web page is formatted for landscape orientation on the display screen, automatically displaying the received web page in landscape orientation on the display screen.

7. The method of claim 1, wherein determining whether the received web page is formatted for the portrait orientation on the display screen of the wireless communication device comprises examining the contents of the received web page.

8. A system for restructuring content on a display screen of a mobile device, the system comprising:
a. one or more processors; and
b. a non-transitory memory containing instructions that, when executed by said one or more processors, causes said one or more processors to perform a set of steps comprising:
i. acquiring the content from a website by the mobile device, wherein the content is available in a plurality of web pages, and wherein the web pages are formatted for one of a first orientation and a second orientation on the display screen of the mobile device;
ii. determining page information for the first orientation and the second orientation of the display screen for each of the web pages, wherein the page information comprises a first character and a last character of each of the web pages;
iii. positioning markers on the web pages based on the determined page information;
iv. restructuring the content based on position of the markers on reorientation of the mobile device from one of the first orientation to the second orientation and from the second orientation to the first orientation of the mobile device; and
v. displaying restructured content on the display screen of the mobile device.
